(19) United States
(12) Patent Application Publication
(10) Pub. No.: US 2006/0185146 A1
(43) Pub. Date: Aug. 24, 2006

(54) Pulse synchronized load stabilization for fastening torque recovery

(76) Inventors: Lawrence Piggins, Livermore, CA (US); Michael Ritchey, Grand Blanc, MI (US); Richard T. Szwast, Farmington Hills, MI (US); Thomas R. Jozwiak, Taylor, MI (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 11/060,613

(22) Filed: Feb. 18, 2005

(51) Int. Cl. B23Q 17/00; B25B 23/14

(52) U.S. Cl. 29/407.02; 73/862.21

(57) ABSTRACT

A pulse synchronize load stabilization routine for adjusting a fastener to a desired torque level with a tool operatively connected to a fastener is provided. The method includes applying a first level of current to the tool, pulsing the tool to cause the fastener to rotate and measuring a dynamic torque load on the fastener while it is rotating. A computer readable medium containing an executable code for adjusting a fastener with a tool operatively connected to the fastener is also provided. Executable code includes a routine which causes the tool to run in a first velocity speed control mode determined if a torque load is at a predetermined level and if the torque load is at a predetermined level, then apply a pulse synchronize load stabilization sequence.

### FIELD OF THE INVENTION

The present invention relates generally to tools used for turning fasteners such as nuts and bolts. More particularly, the present invention relates to computer controlled tools used for turning multiple fasteners at one time.

### BACKGROUND OF THE INVENTION

Often, two assemblies may be attached to each other by using fasteners such as nuts or bolts. In many cases, two objects are attached to each other by using a plurality, sometimes an array, of nuts and bolts. For example, a car wheel attaches to a car often by four to eight lug nuts arranged in an annular array. For a variety of reasons, it is important that the lug nuts be turned to a specific torque when attaching the wheel to the car.

One problem often encountered when trying to torque a fastener to a specific torque level is that once the fastener is torqued to the desired torque level, that torque level may change in response to other nearby fasteners being torqued. This problem is often exemplified by again using the car wheel example. A first lug nut may be tightened as much as possible by hand. Then once a lug nut, often beside of the first lug nut, is tightened and torqued down, it is then often noticed that the first torque lug nut is now loose and must be again tightened. However, once the first lug nut is again tightened, then the second lug nut, located opposite the first, may be loosened slightly. This problem is related to the fact that the torque at one fastener can affect the torque level of a nearby fastener.

In many environments, such as manufacturing environments, multiple fasteners may be tightened at the same time by a single tool operating all of the fasteners, and as mentioned, the tightening of one fastener slightly before or after a second fastener can result in the fasteners having different actual torque levels than what was indicated when those fasteners were tightened and measured.

Accordingly, it is desirable to provide a method and apparatus that can control a tool for attaching a fastener or multiple fasteners to a desired torque level and controlling that tool so that the actual torque level of all the fasteners, once all of the fasteners have been torqued, is at a desired level.

### SUMMARY OF THE INVENTION

The foregoing needs are met, to a great extent, by the present invention, wherein in one aspect an apparatus is provided that in some embodiments attaches multiple fasteners to a desired torque level. A pulse synchronous load stabilization method for adjusting a fastener to a desired torque level with a tool operatively connected to the fastener is provided. The method includes: applying a first level of current to the tool, pulsing the tool to cause the fastener to rotate, and measuring a dynamic torque load on the fastener while it is rotating.

In accordance with one embodiment of the present invention, a method of pulse synchronous load stabilization method for adjusting a fastener to a desired torque level with a tool operatively connected to the fastener is provided. The method includes: (a) setting up high and low current thresholds, (b) applying current to the tool at the low thresholds for a predetermined length of time, (c) determining whether all fasteners are synchronized, (d) if the fasteners are synchronized then skipping to step (g), if the fasteners are not synchronized, then executing steps (e)-(f), (e) applying current to the tool at the high threshold, (f) measuring a level torque associated with fasteners, if the torque level exceeds a desired level, return to step (b), if the torque level does not exceed a desired level, go to step (d), (g) pulsing current to tool while the tool is in a velocity control mode and measure dynamic torque associated with fasteners, and (h) repeating steps (b)-(g) at least one of a predetermined number of times or until a desired torque level is achieved.

In accordance with another embodiment of the present invention, a method for adjusting a fastener with a tool operatively connected to the fastener is provided. The method includes running the tool in a first velocity speed control mode, determining if a torque load is at a predetermined level, and if the torque load is at the predetermined level, then applying a pulse synchronous load stabilization sequence.

In accordance with yet another embodiment of the present invention, a method for adjusting a fastener with a tool operatively connected to the fastener is provided. The method includes: running the tool in a high velocity speed control mode, determining if the torque level is at a synchronization level, and if the torque level is at a synchronization level, then applying a pulse synchronous load stabilization sequence, running the tool in a low velocity speed control mode, determining if the torque level is at a predetermined level, if the torque level is at a predetermined level, then: applying a pulse synchronous load stabilization sequence a second time.

In accordance with yet another embodiment of the present invention, a computer readable medium containing executable code for adjusting a fastener with a tool operatively connected to the fastener is provided. The code contains commands for running the tool in a first velocity speed control mode, determining if a torque load is at a predetermined level, and if the torque load is at the predetermined level, then: applying a pulse synchronous load stabilization sequence.

In accordance with yet another embodiment of the present invention, a computer readable medium containing executable code for using pulse synchronous load stabilization for adjusting a fastener to a desired torque level with a tool operatively connected to the fastener is provided. The code contains commands for applying a first level of current to the tool, pulsing the tool to cause the fastener to rotate, and measuring a dynamic torque load on the fastener while it is rotating.

In accordance with yet another embodiment of the present invention, a computer readable medium containing executable code using pulse synchronous load stabilization for adjusting a fastener with a tool operatively connected to the fastener is provided. The code contains commands for running the tool in a high velocity speed control mode, determining if the torque level is at a synchronization level, and if the torque level is at a synchronization level, then applying a pulse synchronous load stabilization sequence, running the tool in a low velocity speed control mode, determining if the torque level is at a predetermined level, if the torque level is at a predetermined level, then applying a pulse synchronous load stabilization sequence a second time.

In accordance with yet another embodiment of the present invention, a computer readable medium containing executable code using pulse synchronous load stabilization for adjusting a fastener with a tool operatively connected to the fastener is provided. The code contains commands for: (a) setting up high and low current thresholds, (b) applying current to the tool at the low thresholds for a predetermined length of time, (c) determining whether all fasteners are synchronized, (d) if the fasteners are synchronized then skip to step (g), if the fasteners are not synchronized, then execute steps (e)-(f), (e) applying current to the tool at the high threshold, (f) measuring level torque associated with fasteners, if the torque level exceeds a desired level, return to step (b), if the torque level does not exceed a desired level, go to step (d), (g) pulsing current to tool while the tool is in a velocity control mode and measure dynamic torque associated with fasteners, and (h) repeating steps (b)-(g) at least one of a predetermined number of times or until a desired torque level is achieved.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a cut away side view illustrating a tool for turning multiple fasteners to a specific torque level attached to a computer controlling the tool according to one embodiment of the invention.

FIG. 2 is a flowchart illustrating steps that may be followed in accordance with one embodiment of the invention in a fastening process.

FIG. 3 is a flowchart of a pulse synchronized load stabilization subroutine indicated twice in FIG. 2.

### DETAILED DESCRIPTION

The invention will now be described with reference to the drawing figures, in which like reference will refer to like parts throughout. An embodiment in accordance with the present invention provides a computer program that operates a computer configured to control a fastening tool for fastening table fasteners. The computer program controls the tool to tighten the fasteners to a predetermined level of torque.

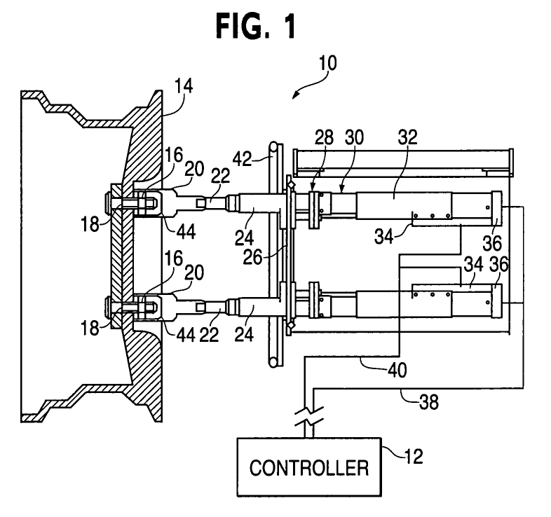

FIG. 1 illustrates an example of a tool 10 controlled by a controller 12 in accordance with the invention. The tool 10 shown in FIG. 1 is a wheel nut multiple. The tool 10 is referred to as a multiple because the tool 10 tightens multiple fasteners at one time. FIG. 1 illustrates one use of the tool 10 in accordance with the invention. The tool 10 is used on a car wheel 14 to tighten lug nuts 16 on lug nut bolts 18. Multiple lug nuts 16 are tightened by the tool 10 at one time.

As shown in FIG. 1, sockets 20 are placed over the lug nuts 16 to tighten the lug nuts 16. The sockets 20 are attached to sliding spindles 22. The sliding spindles 22 are spring loaded in order to permit the socket 20 to continue to stay in communication with the lug nut 16 as the lug nut 16 is tightened down on the lug bolt 18. The sliding spindle 22 is supported by sliding spindle supports 24 which are attached to a plate 26.

A transducer 28 is located around shafts which are connected to the sliding spindle 22. The transducer 28 measures torque that is being applied to the lug nuts 16. The transducer 28 uses strain gages to mechanically measure the torque applied to the lug nut 16.

A gearing assembly 30 transfers power from the motor assembly 32 to the sliding spindle 22. The gearing assembly 30, in some embodiments, maybe modular and may be removed and replaced by another gearing assembly 30 to provide different gear ratios to provide more torque and less speed or less torque and more speed according to an operator's desire or requirements of a particular system.

In one embodiment, the motor 32 provides high shaft speed but relatively low torque is delivered to the sliding spindles 60. The gearing assembly 30 provides lower speed and a higher amount of torque. In one embodiment of the invention, the gearing assembly provides a 25:1 reduction in speed. The motor 32 is a direct current (DC) brushless motor, and there is a motor 32 and gearing assembly 30 for each sliding spindle 22.

An intelligent tool interface 34 and a PC board 36 are attached to the motor assembly 32 in order to provide power and control to the motor 32. The intelligent tool interface 34 and the PC board 36 are connected to a controller 12 through a power connection 38 and control connection 40. The control connections 40 provide torque feedback, motor commutation and other data to the controller 12 so that the controller 12 can run the motor 32 at the desired speed and power levels. The power connections 38 provide operating power to the motor 32. In some embodiments of the invention, the power connections 38 to the motor 32 may be directly connected to a power source and not connected to a power source via controller 12.

Operation of the wheel nut multiple tool 10 includes programming a control sequence into the controller 12. In some embodiments of the invention, the controller 12 is a field programmable microcontroller which may include a PC computer or any other programmable type of controller. In other embodiments of the invention, the controller 12 is not programmable but includes hardware and/or software to control the wheel nut multiple tool 10 according to a preprogrammed program.

To attach the tool 10 to the fasteners to be tightened, an operator brings the fasteners to be tightened in close proximity to the sockets 20. The sockets 20 may be turned so that they align with the lug bolts 18 by having an operator turn the handle 42.

The tool 10 permits limited movement of the handle 42 which, in turn, turns or rotates the sliding spindle 22 and sockets 20 in order to permit them to align with the lug bolts 18 and lug nuts 16. Once the sliding spindle 22 and sockets 20 are aligned with the lug nuts 16 and lug bolts 18, the wheel 14 is brought closer to the tool 10. In some embodiments of the invention, the sockets 20 may extend toward the lug nuts 16 and capture them within a cavity 44 inside the socket 20. Once the sockets 20 are engaged with the lug nuts 16, the tool 10 is engaged and tightens the lug nuts 16 in accordance with control signals received from the controller 12.

While the illustrated embodiment shown in FIG. 1 is a wheel nut multiple tool 10, other types of tools may be used in accordance with the invention. In general, any type of tool for rotating fasteners were a torque level applied to the fastener is desired to be at a predetermined level, may be used in accordance with the invention. Although lug nuts 16 are shown and described herein, any type of relating fastener may be torqued in accordance with the invention.

The controller 12 will control the tool 10 in accordance with instructions programmed in the controller 12. In some embodiments of the invention, the control sequence programmed on the controller 12 includes a fastening cycle 46.

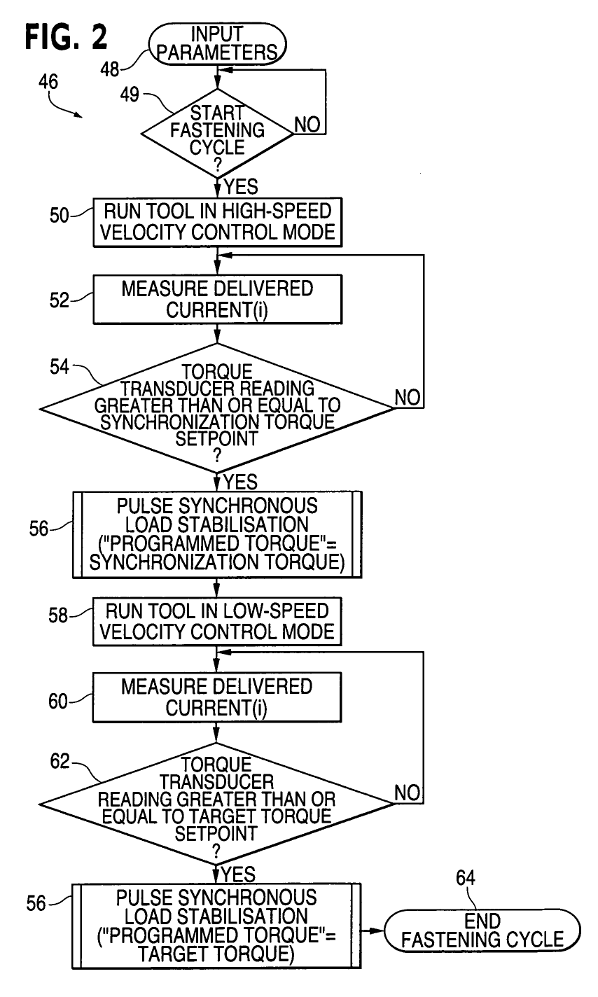

FIG. 2 is a flow diagram of the fastening cycle 46. The first step in the fastening cycle 46, step 48, is to input certain parameters into the controller 12. The parameters in some embodiments of the invention are the synchronization torque, the target torque, the pulse synchronous load stabilization (PSLS) current (N %), PSLS dwell (T milliseconds), and PSLS repeat (X). These parameters can be changed from job to job and are set according to individual needs of a specific set of fasteners to be tightened and torqued by the tool 10. For example, the synchronization torque (the torque level the fasteners are to be when the synchronous load stabilization routine is run a first time) must be chosen and entered into the controller 12. The target torque (the torque level the fasteners are to be when starting the pulse synchronous load stabilization routine is run a final time) also must be determined and entered.

Another parameter is the PSLS current (N %) with high and low load thresholds is determined and entered into the controller 12. The high and low load thresholds are related to the fact that applying current to a motor 32 is a rough approximation of how much torque is applied on the fastener. However, because the fasteners often have torque applied, even when the fastener is not moving due to friction and other reasons, a high and low amount of current applied to the motor 32 which will still not turn the fastener, is determined. The high and low are generally considered a plus and minus of some percentage of an average torque load.

Another programmable parameter is the PSLS dwell (T milliseconds). The PSLS Dwell is how many milliseconds to apply or dwell at the low threshold on the fastener. Also, a number of pulses of current that are applied to the motor 32 which results in pulses of torque applied to the fasteners is a programmed parameter.

The PSLS repeat (X) is the amount of times the dwell synchronizing pulse process is repeated. The synchronizing pulse process may not be repeated as many times as indicated by the PSLS repeat parameter if the target torque is achieved before the process is repeated PSLS (X) times.

Once these parameters have been determined according to the individual circumstances of the fasteners and entered into the controller 12, the next step 49 is to determine if the fastening cycle will be run. If so, the next step 50 is to run the tool 10 at a high speed velocity control mode. In this mode, the velocity at which the fasteners are turned is controlled and the fastener is turned at a high rate of speed down to where the fastener contacts what the fastener will ultimately be urging against (which is a wheel rim 14 in the illustrated embodiment). Turning the fastener until it initially contacts what the fastener will ultimately urge against is called the rundown process. Step 52 is to measure the current applied or delivered to the motor 32 during the running of the tool 10 in the high speed velocity control mode. Current applied or delivered to the motor 32 is a rough approximation of the torque applied to the fastener. Thus, steps 50 and 52 are occurring simultaneously in some embodiments of the invention. In other embodiments of the invention, they may be done sequentially.

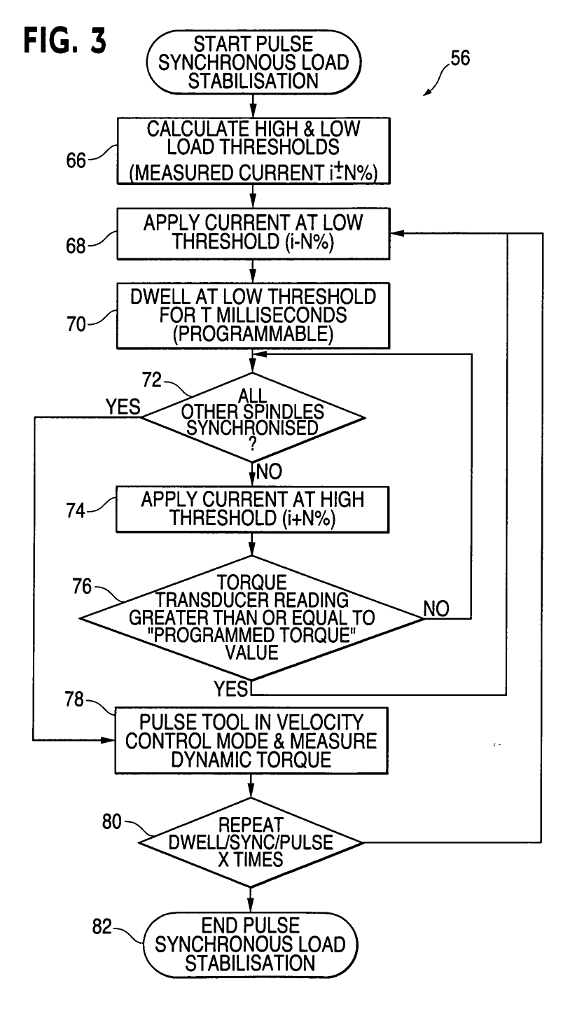

Once the current delivered to the motor 32 has been measured as in step 52, the next step, step 54 is to compare torque transducer 28 reading input into the computer/controller 12 versus the synchronization torque set point. If the torque transducer reading is less than the synchronization torque set point, then the tool 10 will continue to run in a high velocity control mode, and the current delivered to the motor 32 is monitored (steps 50 through 54 are repeated). If the measured torque transducer reading is indicative that the torque is at the torque set point, then the pulse synchronize load stabilization subroutine (step 56), as illustrated in FIG. 3, is applied.

The pulse synchronize load stabilization subroutine 56 is done after the high and low thresholds have been set up and determined and programmed into the controller 12 as in step 66. In some embodiments of the invention, the high and low thresholds are determined and set up in step 48 (see FIG. 2). The thresholds are used to approximate a peak load on the fastener based on measured peak current plus or minus a programmed percentage. Next, the low current threshold is applied to the tool's motor 32 which applies a low threshold of torque as illustrated by step 68 in FIG. 3. Applying the current at the low threshold will maintain torque on the fastener, without overshooting the programmed torque load. The motor 32 will dwell at the low threshold amount of current for some amount of time (T) in milliseconds (step 70 in FIG. 3). The time (T) program parameter is set by a tool operator.

The next step 72, is where all the spindles 22 are synchronized. The torque on each spindle 22 is determined by the transducer 28, and reported to the controller 12 via the intelligent tool interface 34. The controller 12 determines if all the spindles 22 have reached the synchronization torque, and have dwelt in the torque threshold for a minimum amount of time. If the spindles 22 are synchronized, then the next step, as illustrated in step 78, is accomplished where the tool 10 is pulsed in velocity-control mode, and each pulse of current sent to the motor 32 will cause the fastener to turn slightly, thus a dynamic measure of torque may be determined by the transducer 28. Once all the spindles 22 have synchronized at their dwell point, the tool 10 is operated at very low speed velocity mode, and the spindle 22 is turned less than one degree to determine the dynamic torque on the joint. This stabilizes the clamp force or the load on the fastener.

The next step, as illustrated as 80 in FIG. 3, is to repeat the apply current at low threshold (i±N %) step 68 and continue through the subroutine 56 back to step 80 a predetermined amount of times as programmed previous to the commencement of the pulse synchronize load stabilization 56 subroutine.

Returning now to step 72 shown in FIG. 3, if all the spindles 72 are not synchronized, then extra steps, step 74 and 76 are taken. In step 74, current is applied at a high threshold. As illustrated as step 76 in FIG. 3, the transducer 28 reads the torque load with the high current threshold to determine if it exceeds the programmed torque level. The transducer 28 is monitored by the controller 12 during the high threshold dwell to provide a more accurate torque threshold, and guarantee the joint does not overshoot its programmed torque. If the transducer 28 reading does not exceed the program torque, then the subroutine returns to step 72 to determine if all the spindles 22 are synchronized. If the transducer 28 reading indicates that the programmed torque has been exceeded, then current is applied at the low threshold as indicated in step 68, and then the subroutine continues from step 68 until the end of the synchronous load stabilization step 82 is achieved.

Once the pulse synchronize load stabilization 56 subroutine has been run then, and the low speed velocity control mode as indicated by step 58 in FIG. 2 is run. The tool 10 is run in the low speed run to approach the final target torque. Then as indicated by step 60, the current is measured during the tightening process of running the tool 10 in the low speed velocity control mode of step 60.

At this point, the torque transducer reads the torque on the spindle 22. If the torque or the spindles 22 achieves the final torque target, then the pulse synchronize load stabilization 56 is again run, and once run a second time, the cycle of fastening is then completed. However, if the torque transducer reading, as measured in step 62, does not reach the final target torque, then the tool 10 continues to run in a low speed velocity control mode is indicated by step 58, and the current delivered to the motor 32 is continues to be measured as indicated by step 60. And again as indicated by step 62, the torque transducer reading is compared against the final target torque.

If the torque transducer reading is at or greater than the final target torque, then the pulse synchronous load stabilization routine 56 is run a predetermined number of times, or until a final torque value for all of the fasteners is met. The fastening cycle is then ended (step 64).

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A pulse synchronous load stabilization method for adjusting a fastener to a desired torque level with a tool operatively connected to the fastener comprising:
applying a first level of current to the tool;
pulsing the tool to cause the fastener to rotate; and
measuring a dynamic torque load associated with the fastener while it is rotating.

2. The method of claim 1, further comprising repeating the method until a desired torque load is measured.

3. The method of claim 1, further comprising repeating the method a predetermined number of times.

4. The method of claim 1, further comprising applying the method to a tool operatively connected to a plurality of fasteners.

5. The method of claim 4, further comprising applying the first level of current to the tool for a predetermined amount of time, and determining if all of the other fasteners are synchronized.

6. The method of claim 5, further comprising applying a second level of current to the tool if the plurality of fasteners are not synchronized.

7. The method of claim 6, further comprising measuring a torque associated with the fasteners and applying the first level of current to the tool of the torque exceeds a predetermined level.

8. The method of claim 5, wherein the pulsing step is done when the fasteners are synchronized.

9. The method of claim 8, further comprising repeating the method at least one of a predetermined number of times and until a predetermined level of torque is measured.

10. A method of pulse synchronous load stabilization method for adjusting a fastener to a desired torque level with a tool operatively connected to the fastener comprising:
(a) setting up high and low current thresholds;
(b) applying current to the tool at the low thresholds for a predetermined length of time;
(c) determining whether all fasteners are synchronized;
(d) if the fasteners are synchronized then skipping to step (g), if the fasteners are not synchronized, then executing steps (e)-(f);
(e) applying current to the tool at the high threshold;
(f) measuring a level torque associated with fasteners, if the torque level exceeds a desired level, return to step (b), if the torque level does not exceed a desired level, go to step (d);
(g) pulsing current to tool while the tool is in a velocity control mode and measure dynamic torque associated with fasteners; and
(h) repeating steps (b)-(g) at least one of a predetermined number of times or until a desired torque level is achieved.

11. A method for adjusting a fastener with a tool operatively connected to the fastener comprising:
running the tool in a first velocity speed control mode;
determining if a torque load is at a predetermined level; and
if the torque load is at the predetermined level, then:
applying a pulse synchronous load stabilization sequence.

12. The method of claim 11, wherein the torque level is determined by a transducer operatively connected to spindles on the tool.

13. The method of claim 11, further comprising running the tool in a speed velocity control mode if the torque load is not at a desired level, then repeating the determining if a torque load is at a predetermined level step.

14. A method for adjusting a fastener with a tool operatively connected to the fastener comprising:
running the tool in a high velocity speed control mode;
determining if the torque level is at a synchronization level; and
if the torque level is at a synchronization level, then:
applying a pulse synchronous load stabilization sequence;
running the tool in a low velocity speed control mode;
determining if the torque level is at a predetermined level;
if the torque level is at a predetermined level, then:
applying a pulse synchronous load stabilization sequence a second time.

15. The method of claim 14, wherein the torque level is determined by a transducer operatively connected to spindles on the tool.

16. The method of claim 14, further comprising:
running the tool in a high speed velocity control mode if the torque load is not at a synchronization level, then repeating the determining step if a torque load is at a synchronization level; and
running the tool in a low speed synchronous load stabilization if the torque level is not at a predetermined level, then repeating the determining step if a torque load is at a predetermined level.

17. A computer readable medium containing executable code for adjusting a fastener with a tool operatively connected to the fastener comprising:
running the tool in a first velocity speed control mode;
determining if a torque load is at a predetermined level; and
if the torque load is at the predetermined level, then:
applying a pulse synchronous load stabilization sequence.

18. A computer readable medium containing executable code for using pulse synchronous load stabilization for adjusting a fastener to a desired torque level with a tool operatively connected to the fastener comprising:
applying a first level of current to the tool;
pulsing the tool to cause the fastener to rotate; and
measuring a dynamic torque load associated with the fastener while it is rotating.

19. A computer readable medium containing executable code using pulse synchronous load stabilization for adjusting a fastener with a tool operatively connected to the fastener comprising:
running the tool in a high velocity speed control mode;
determining if the torque level is at a synchronization level; and
if the torque level is at a synchronization level, then:
applying a pulse synchronous load stabilization sequence;
running the tool in a low velocity speed control mode;
determining if the torque level is at a predetermined level; and
if the torque level is at a predetermined level, then:
applying a pulse synchronous load stabilization sequence a second time.

20. A computer readable medium containing executable code using pulse synchronous load stabilization for adjusting a fastener with a tool operatively connected to the fastener comprising:
(a) setting up high and low current thresholds;
(b) applying current to the tool at the low thresholds for a predetermined length of time;
(c) determining whether all fasteners are synchronized;
(d) if the fasteners are synchronized then skip to step (g), if the fasteners are not synchronized, then execute steps (e)-(f);
(e) applying current to the tool at the high threshold;
(f) measuring level torque associated with fasteners, if the torque level exceeds a desired level, return to step (b), if the torque level does not exceed a desired level, go to step (d);
(g) pulsing current to tool while the tool is in a velocity control mode and measure dynamic torque associated with fasteners; and
(h) repeating steps (b)-(g) at least one of a predetermined number of times or until a desired torque level is achieved.
